(19) United States
(12) Patent Application Publication
(10) Pub. No.: US 2017/0243038 A1
(43) Pub. Date: Aug. 24, 2017

(54) METHODS AND SYSTEMS TO RECONCILE POSTAL AUTHORITY MAIL PIECE ERROR REPORTS WITH DATA RECORDS COLLECTED DURING MAIL PIECE PROCESSING PRIOR TO DELIVERY BY THE POST AUTHORITY

(71) Applicant: Bell and Howell, LLC, Durham, NC (US)

(72) Inventors: Brian Bowers, Mundelein, IL (US); Michael R. Swift, Libertyville, IL (US); Steven Seburn, Buffalo Grove, IL (US)

(21) Appl. No.: 15/438,425

(22) Filed: Feb. 21, 2017

Related U.S. Application Data
(60) Provisional application No. 62/297,433, filed on Feb. 19, 2016.

(51) Int. Cl. G06K 7/10; G06K 7/14

(52) U.S. Cl. CPC G06K 7/10722; G06K 7/1413; G06Q 2250/50; G06Q 2250/90

(57) ABSTRACT

A method, system, and non-transitory computer readable medium for generating an error reconciliation report include receiving operational input data obtained by one or more automated sensors, as well as receiving electronic data records, in the form of one or more IMb data sources, for each mail piece from manufacturing processes, during mail processing; receiving an error report, which comprises a list of Intelligent Mailer barcodes (IMbs) alleged to contain errors associated therewith, wherein the error report is generated automatically by a postal authority; loading the operational input data and the error report into an IMb database; providing an error reconciliation processor in electrical communication with the IMb database; comparing, using the error reconciliation processor, the operational input data against the list of IMbs from the error report against one or more criteria; and generating an error reconciliation report, which comprises results of the comparing step.

### CROSS-REFERENCE TO RELATED APPLICATION

The present application claims priority to and the benefit of U.S. Patent Application Ser. No. 62/297,433, filed Feb. 19, 2016, the disclosure of which is incorporated herein by reference in its entirety.

### BACKGROUND

The postal authority such as the United States Postal Service (USPS) is heading towards the final implementation of seamless mail acceptance. Seamless mail acceptance refers to acceptance of all mail that is submitted to USPS at a business mail acceptance site (BMU) or detached mail unit (DMU). Acceptance is completed without inspection of the mail pieces, which make up the mailing, to verify that pre-sort and mail quality standards have been met and that the mailing preparer's mailing qualifies for a postage discount. The industry has moved towards using the Full Service Intelligent Mail barcode, where Intelligent Mail barcode is sometimes referred to as the barcode for Intelligent Mail, or IM®, referred to hereinafter as “IMb”. IMb provides tracking to unique mail pieces in data. Each mail piece is evaluated against discount postage standards, during processing by the USPS on mail processing equipment such as a Delivery Point Barcode Sorter (DBCS) or Multi Line Optical Reader (MLOCR). The results of the evaluation are stored in the data record associated with each mail piece, along with the data submitted by the mailer in the MAIL.DAT and other eDoc data record types. The USPS has implemented a tracking and mail quality report card called a “MicroStrategy” report that assesses the customer mail quality against a series of performance metrics, such as undocumented mail pieces, COA errors, Duplicate IMbs and By/For errors; other performance metrics may be added as required. If the mail quality for a given customer is not acceptable, the USPS will assess fines and fees for postage due, which is billed in arrears, as well as, in some instances, penalties in the form of lost postage discounts for future mailings. The USPS has thresholds for such parameters such as undocumented mail pieces, COA errors, Duplicate IMbs and By/For errors. Other analysis parameters will be added as required.

At present, mailing preparer's do not have a method to use the data that may otherwise be available to use in countering the postal authority's claims of quality issues with one or more of the mailing preparer's mailings which, if left unchallenged, will result in fines and additional assessments of postage due in arrears; in some instances, this can include the loss of postal rate discounts for future mailings. Because these “MicroStrategy” reports are generated by the postal authority (e.g., the USPS), the frequency at which they are generated and/or made available to mail preparers is determined by the regulations and procedures in effect at the postal authority at the time and, furthermore, are subject to change. The notice of the allegation of quality issues may come as late as approximately 5 weeks (e.g., 35 days) after the mailing was provided to the postal authority, and it is not uncommon for each mailing to contain a million or more mail pieces.

Hence, a need exists for a processing center to collect metadata associated with a mail piece from each processing step performed on each mail piece of each mailing prior to transfer of the entire mailing to the postal authority for delivery to the addressees. By collecting such metadata, a mailing preparer is able to compare the alleged mail piece errors in the “MicroStrategy” report to the metadata collected for each mail piece in a mailing to either confirm or refute the mail piece errors identified in the “MicroStrategy” report.

### SUMMARY

It has now become routine for the postal authority to claim numerous errors in mailings submitted to them and to levy fines in the form of postage being due, which is billed in arrears, as well as, in some instances, penalties against mail preparers in the form of loss or reduction of future postage rate discounts. The present invention provides a workable solution to challenge such claimed errors by gathering all data (e.g., metadata) associated with the individual mail pieces for all mailings at issue, failed print jobs, or test mailings from a variety of sources. The present invention then performs an analysis to find the IMbs being claimed in error and then to match them with all the records found and see if there is merit to the claimed errors. If the claimed error is meritorious, the error reconciliation processor (e.g., the mailing preparer) creates a report that says, essentially, to not challenge these errors and to accept the assessed postage due and/or the loss or reduction of postage rate discounts for future mailings. Where the error report generated by the error reconciliation processor have data that refutes the allegation of errors, secondary reports for the different categories of alleged errors are generated to seek relief from the postal authority for an assessment that postage is due and/or the loss or reduction of postal rate discounts. The assessing of postage due, as well as the threat of the loss of postage rate discounts for future mailings constitute a great financial exposure for mailing preparers, especially for the pre-sorters that create mailings from multiple mailing originators for delivery by the postal authority in order to obtain the greatest permissible postage rate discounts allowed by such aggregation of mailings.

Exemplary advantages and novel features are set forth in part in the description which follows, and in part will become apparent to those skilled in the art upon examination of the following and the accompanying drawings or may be learned by production or operation of the examples. Advantages of the present teachings may be realized and attained by practice or use of the methodologies, instrumentalities and combinations described herein.

### BRIEF DESCRIPTION OF THE DRAWINGS

The drawing figures depict one or more example embodiments in accordance with the disclosure herein, by way of example only and not by way of limitation. In the figures, like reference numerals refer to the same or similar elements.

FIG. 1 is an example diagram for a method error reconciliation by error processing and verification, in accordance with the disclosure herein.

FIG. 2 illustrates a network or host computer platform, as may typically be used to implement a server, in accordance with the disclosure herein.

FIG. 3 depicts a computer with user interface elements, as may be used to implement a personal computer or other type of work station or terminal device, in accordance with the disclosure herein.

FIG. 4 depicts an example embodiment for error reconciliation processing in a flow chart, in accordance with the disclosure herein.

FIG. 5A is an example barcode identifier using example data containing the unique mail item identifier, in accordance with the disclosure herein.

FIG. 5B is an example embodiment for data, including for a unique mail item identifier capable of being associated with a mail item destined for a sort group, in accordance with the disclosure herein.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

A mail preparer processes a collection of mail pieces, referred to hereinafter as a mailing. The mail preparer must perform specific services for the postal authority before presenting the mailing to the postal authority for delivery. The mail preparer is, for example, a business entity, organization, or individual acting on behalf of one or more mail owners by providing mailing services, for which the mail owners compensate the mailing agent. Mail preparers include, but are not limited to: printers, letter shops, address list providers/managers, mailing agents, postage payment providers, mailing logistics providers, mailing tracking providers, ad agencies, and mailing information managers. The mail preparer performs the following functions, as required, for the mailing: change of address (COA), address accuracy analysis, printing IMb's in the clear zone (e.g., the bottom right of the envelope), ensure adequate barcode quality, presorting the mail pieces based on postal authority delivery rules, and generating documentation that supports the postage discount that is claimed for each mailing. Other processes are performed, as required; these other processes are not limited to the entries found in the list provided above. The mail preparer provides a MAIL.DAT electronic file, which electronically describes the contents of the mailing, to the postal authority when the mailing is presented to the postal authority for delivery. In addition, eDoc data is provided, which includes additional data about the mailing, including, for example, mail owner identification for every mail piece, mail preparer identification (known together as By/For relationship data using either CRID or MID), mail piece details, including IMB, postage, and sortation information, and full tray, as well as pallet, data for the mailing.

The mail preparer collects data about the mailing (e.g., MAIL.DAT, eDoc, and/or operational data) that is needed to rebut claims in the “MicroStrategy” report that mail pieces, or even an entire mailing, contained errors which would, if not countered, would result being charged for postage due for the mail pieces containing the errors, as well as a number of future mailings not qualifying for postage discounts. The data about the individual mail pieces is collected during the initial processing that is performed in order for the mailing to qualify for postage rate discounts, and/or during manufacturing and assembly of the mail piece on an inserter. Each mail piece that comprises a mailing has an IMb associated with it, where the IMb contains a unique identifier that is guaranteed to be unique for 45 days versus all other mail pieces being processed by the postal authority during this 45 day period. The IMb is a unique number printed on the mail piece; the IMb is detected with a barcode reader on the mail processing equipment or is included in the metadata associated with the production run for the mailing that included the mail piece. Hence, data associated with the mail piece in the MAIL.DAT data file and parameters collected in the “MicroStrategy” report are both able to be referenced to the IMb unique identifier. This unique identifier is the same value for a given mail piece for data reported in the MAIL.DAT and eDoc reports, plus data from the “MicroStrategy” report.

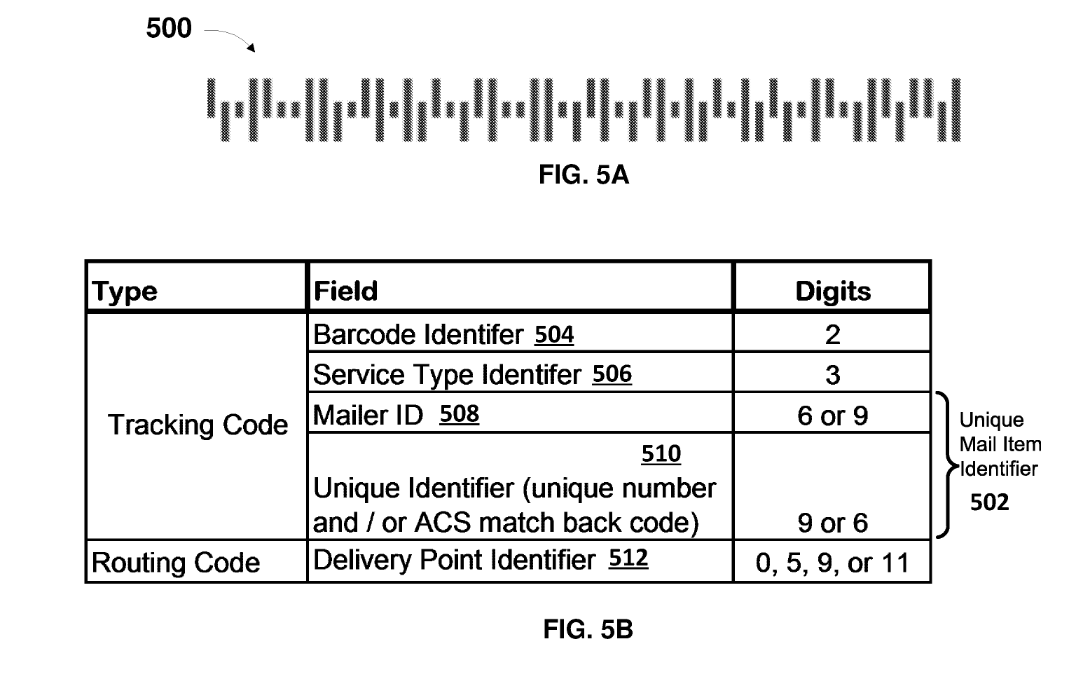

Referring to FIGS. 5A and 5B, a representative example of the IMb used by USPS and a definition of the barcode data fields are shown therein, respectively. As shown in FIG. 5A, an example IMB, generally designated 500, is a height modulated barcode that uses vertical bars of varying heights to encode data. When used to qualify for automation discounts, the IMb 500 is printed, for example, in the address block or in the barcode clear zone, which is generally found on the lower right corner of a mail piece. The IMb 500 contains or otherwise encodes a unique 31-digit identifier, with fields for encapsulating various data, as shown in FIG. 5A. Data fields encoded into the IMb 500 are shown in FIG. 5B, and include, but are not limited to: a two-digit barcode identifier 504, a three-digit service type identifier 506, a six- or nine-digit mailer identifier (ID) 508, a nine- or six-digit unique identifier 510 or, alternatively, address correction service (“ACS”) match back code 510, and a delivery point identifier 512 (e.g., the delivery ZIP code, which can be zero-, five-, nine- or eleven-digits). The service type identifier 506 specifies a particular postal authority approved mail class and service(s) to be executed for each specific mail piece, such as First Class with CONFIRM, ACS, etc., when the mail piece is to be delivered by the United States Postal Service (USPS). For the purposes of discussion relating to the current invention, and in the IMB-type example of FIG. 5A, the unique number is “unique” in that it is used on only one mail piece of the identified mail preparer for a specific period of time (e.g., 45 days), typically specified by the postal authority in the applicable standard, although the mail preparer may reuse the number after expiration of the specified period of time. The unique number identifier in the IMb may, for example, be assigned at the discretion of the mail preparer and, according to the current postal authority standard for IMBs, must be certifiably unique for at least 45 days (e.g., the specified time period in the IMb example). The delivery point identifier 512 contains ZIP Code data of varying ranges (e.g., 5-digit ZIP versus 11-digit ZIP). In the IMb example of FIG. 5A, the combination of the unique identifier 510 and the mailer ID 508 is one example of what is referred to together herein as a unique mail item identifier 502. Of course, those skilled in the art will recognize that one or more combinations of data fields may comprise the unique mail item identifier 502, which needs to be unique only for each class of mail, encoded and/or imprinted on the mail piece as a barcode or other form of readable postal authority approved code.

The USPS “MicroStrategy” report data and the MAIL.DAT and eDoc data are compared to identify discrepancies between the two reports. The “MicroStrategy” report includes the following error parameter types:

Undocumented Mail Pieces:

Pieces of mail in which are received by the postal authority, but which are not accounted for in the MAIL.DAT submissions from the mail preparer. These undocumented mail pieces are attributed to a customer (e.g., the mail preparer) based on the MID on the mail piece. The customer is then charged the single piece rate for the undocumented mail piece;

COA (Change of Address) Errors:

A list of mail pieces that were received by the postal authority that have a move notice associated with the mail piece and should have had a COA applied to the mail piece, but did not have such COA applied. Where the postal authority is the USPS, the determination of whether a COA error exists is based on the delivery point bar code on the mail piece in the IMb using the PARS process. When the number of mail pieces with a COA error exceeds a threshold, the USPS will assess a fine for these mail pieces and can even retroactively “fail” a mailing submission;

Duplicate IMbs:

One of the requirements for full service is that the IMb is to be unique for 45 days. This can be a challenge at times. However, the USPS monitors duplicates and bills customers in arrears for mail pieces having an IMb that isn't unique based on the MID and the sequence number; and

By/for Errors:

The postal authority tracks the performance of mail preparers using the CRID and the MID. MIDs are traceable back to a single CRID. CRIDs are the unique mailing address for a mail preparer or mail owner. The USPS tracks these errors based on a threshold. When this threshold is exceeded, fines are assessed.

Other error parameter types are able to be added, as required, for seamless inspection. Thresholds are set for each error parameter type to determine when an error has occurred too many times in a given mailing to result in a reduction of the pre-sort discount or a total discount loss.

Processing of the “MicroStrategy” report can for example proceed as described below.

All IMbs that are generated for any reason within a mail site are sent to a server in a MAIL.DAT file, where all IMbs from all mail sites are aggregated. The MAIL.DAT file indicates where each IMb originates from and also possesses a time and date stamp for the mailing records. As IMbs are processed through the entire process of generating the mailing, the record of the occurrence is sent to the IMb server. This essentially creates a life cycle for IMBs, from creation to delivery to the USPS, within a mailing site. In some aspects, mail pieces with IMbs generated somewhere else (e.g., at another mail site) can be loaded and/or uploaded into the IMb database for each mailing process at the site.

When mail pieces are detected on a sorter, the first reader detects the address block bar code and also performs an optical character recognition (OCR) process to any text found in the address block. The system determines if there is a move (e.g., from a change of address) associated with the indicated recipient of the mail piece. The record returned to the server will indicate either that a change of address is needed for the particular mail piece or that a change of address is not needed for the particular mail piece. The By/For information, when known, is also sent to the IMb server along with the IMb. Any sort decision and the mode that the mail piece was in is also tracked and reported.

When the USPS detects IMbs that are indicating a failure on the mail preparer's part, a list of such defective IMbs are included in a file that is then loaded into the server and the database will be searched for all records containing that IMb and generate a corresponding report. The various reports are broken out to ease the reporting and payment aspects with the USPS.

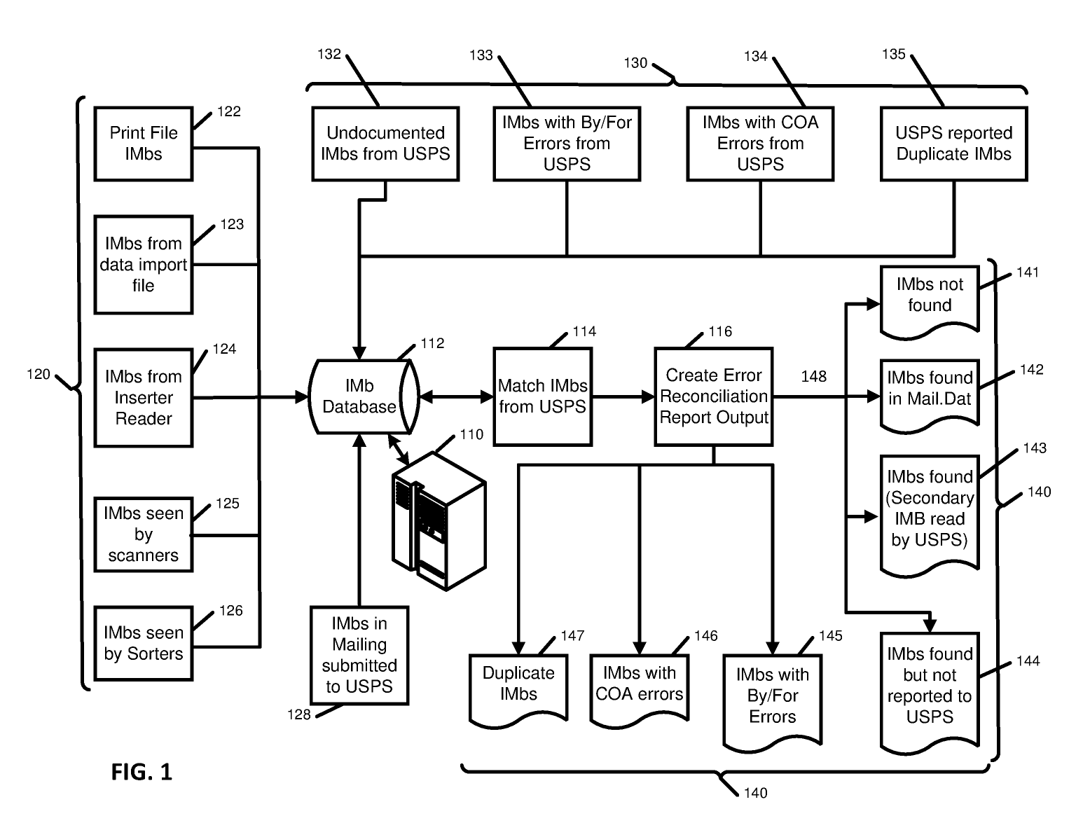

Reference now is made in detail to the examples illustrated in figures (also, FIGS. 1 through 4. FIG. 1 illustrates a method of processing errors for error reconciliation. The error reconciliation processor 110 maintains an IMb database 112 for every mail piece in a mailing. Each mail piece is identified and referenced by the unique ID number coded in the Intelligent Mail barcode (IMb). The mail piece processing steps that occur before delivery of the mail pieces, as a part of a mailing, to the postal authority, generate metadata associated with processing events (e.g., “manufacturing processes”) on printers, inserters, sorters and other equipment in the mail factory. In addition, data records associated with the mailing are parsed and added to the metadata in the IMb database 112. Data from more than one mailing may be added. Furthermore, the IMb database may, in some embodiments, receive the IMb data records and metadata and store these inputs as each mailing is prepared and/or delivered to the postal authority for delivery to each addressee. A representative example of input data sources, generally designated 120, is shown in FIG. 1. IMbs from printer control files 122 that are slated to be printed, or that have been printed, are input into the IMb database 112. IMbs from data import files 123 define the mailing properties; these IMbs 123 are parsed and added to the IMb database 112. MID and CRID identifications, which identify the mail owner, mail preparer, and any other necessary records, are found in the IMbs found in the data import files 123. IMbs from the mail piece manufacturing equipment 124, such as inserters and wrappers, are recorded, along with machine event data and mail piece tracking data through the equipment, and are then transferred to the IMb database 112. IMbs detected by automated sensors (e.g., scanners 125) located at various stages of processing collect additional data about the printed material on each mail piece, such as key line, endorsements, COA requests, IBI data, and address data. IMbs from the sorters 126 is obtained as a part of the sorting process and provided to the IMb database 112. The scanner maybe an area capture camera, a line scan camera, or a barcode reader. The input data sources 120 provide evidence of the mail piece status through tracking and reading of IMbs at numerous stages of manufacturing and pre-processing, through print data and data files. The input data sources 120 are used to compare against postal authority error reports (e.g., “MicroStrategy” reports), generally designated 130. Other input data sources 120 are possible and envisioned for inclusion in the input data reporting process, in accordance with this disclosure, and may be accommodated in the present invention to meet other design requirements associated with enabling postal authority seamless inspection and pre-delivery processing and data reporting.

IMBs in mailing documentation 128 submitted to the postal authority with a mailing contain an accounting of all mail pieces in the mailing, including the IMbs for each mail piece in the mailing. The mailing documentation may be presented in a format compatible with MAIL.DAT. The IMb mailing documentation 128 is parsed and added to the IMb database 112 as a record of all the mail pieces that are expected in the mailing.

Representative examples of postal authority error reports 130 are illustrated in FIG. 1. IMbs of undocumented mail pieces 132 received by the postal authority, but not accounted for in the MAIL.DAT submissions, are identified. These undocumented mail pieces are attributed to a customer based on the MID on the mail piece metadata, and a fee (e.g., postage due associated with the mail pieces having the errors) is requested or a penalty (e.g., loss or reduction of postage rate discounts) is imposed. The undocumented mail piece IMbs 132 are transferred to the error reconciliation processor 110 and saved in the IMb database 112. IMbs associated with By/For errors 133 identify the traceability of MID and CRID mail owner data to a single (e.g., correct) CRID. Inconsistencies in the IMb data are identified and sent to the error reconciliation processor 110 for addition to the IMb database 112. IMbs with COA errors 134 are reported and sent to the error reconciliation processor 110 for addition to the IMb database 112. Duplicate IMbs 135 detected by the postal authority are sent to the error reconciliation processor 110 for addition to the IMb database 112. Other postal authority error reports 130 are possible and envisioned for inclusion in postal authority error reporting process, in accordance with this disclosure, and may be accommodated in the design to meet design requirements associated with postal authority seamless inspection.

As IMbs found in the error reports 130 are received from the postal authority for individual mailings that have gone through the delivery process, the error reconciliation processor 110 matches, in step 114, these IMbs 130 the IMbs from the input data sources 120. The IMbs found in the error reports 130 may, in some embodiments, be parsed, so that IMbs associated with only a single mailing may be identified and loaded into the IMb database 112, rather than all of the IMbs listed in the error reports 130. This allows a mail preparer to further investigate the source of the IMbs having any errors after validation, in order to enact processing improvements and/or to seek remuneration from a mail owner (e.g., where the mail preparer is not also the mail owner) for the back postage fees due. The individual mail piece metadata collected from the input data sources 120 are analyzed versus the IMbs from the error reports 130 and error reconciliation reports, generally designated 140, are generated. The error reconciliation reports 140 are generated by the data comparison algorithms, step 116. The error reconciliation reports 140 generally include multiple classes of results, including, for example, listings of IMbs not found 141, IMbs found in MAIL.DAT 142, IMbs found in a secondary read by the postal authority 143, IMbs found but not reported to the postal authority 144, confirmation that IMbs were found with By/For errors 145, confirmation of IMbs with COA errors 146, and duplicate IMbs 147 within a mailing and across mailings. Other error reconciliation reports are possible and envisioned for inclusion in the output of the analysis process 116, in accordance with this disclosure, and may be accommodated in the design to meet design requirements associated with resolving postal authority error claims and accompanying fines, fees, and/or penalties.

As described above with FIG. 1, functions relating to the operation of the error reconciliation processor 110 are implemented in one or more computers. The error reconciliation processor 110 is configured as either a server or a computer. The error reconciliation processor 110 is network connected to the source of the postal authority error reports 130 and to control systems for mail processing equipment and scanners and mailing data file records (e.g., input data sources 120). Although special purpose devices may be used, such devices also may be implemented using one or more hardware platforms intended to represent a general class of data processing device commonly used to run “server” programming so as to implement the functions discussed above, albeit with an appropriate network connection for data communication.

As known in the data processing and communications arts, a general-purpose computer typically comprises a central processor or other processing device, an internal communication bus, various types of memory or storage media (RAM, ROM, EEPROM, cache memory, disk drives etc.) for code and data storage, and one or more network interface cards or ports for communication purposes. The software functionalities involve programming, including executable code as well as associated stored data. The software code is executable by the general-purpose computer that functions as the control processor 170 and/or the associated terminal device. In operation, the code is stored within the general-purpose computer platform. At other times, however, the software may be stored at other locations and/or transported for loading into the appropriate general-purpose computer system. Execution of such code by a processor of the computer platform enables the platform to implement the methodology for tracking of mail items through a postal authority network with reference to a specific mail target, in essentially the manner performed in the implementations discussed and illustrated herein.

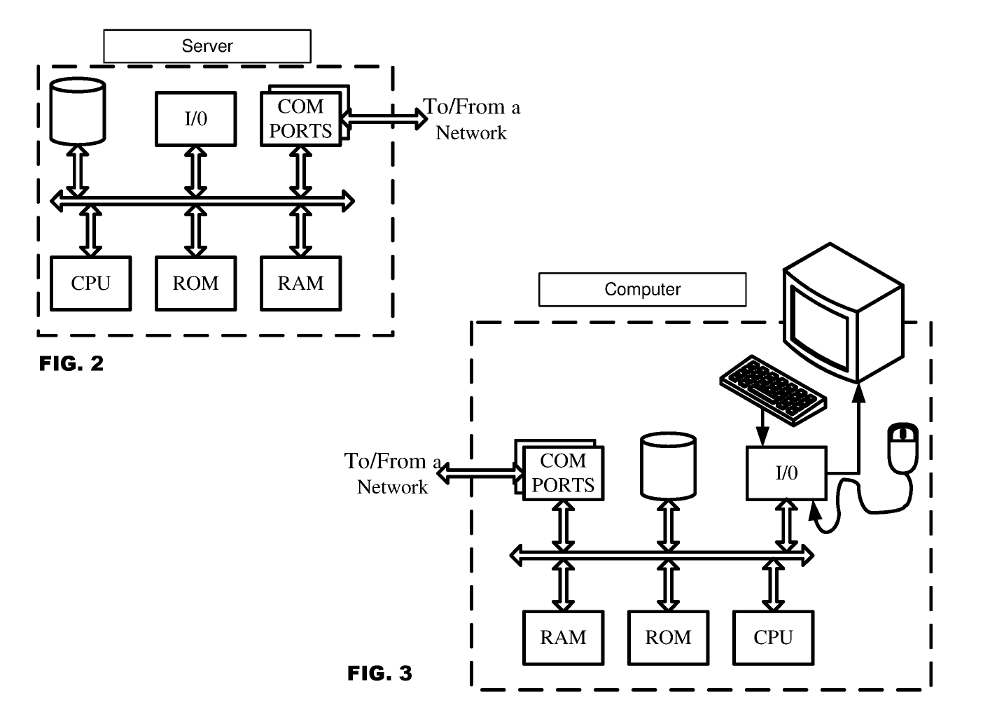

FIGS. 2 and 3 are schematic functional block diagram illustrations of general purpose computer hardware platforms. FIG. 2 illustrates a network or host computer platform, as may typically be used to implement a server. FIG. 3 depicts a computer with user interface elements, as may be used to implement a personal computer or other type of work station or terminal device, although the computer of FIG. 2 may also act as a server if appropriately programmed. Those having ordinary skill in the art should be adequately familiar with the structures, programming, and general operation of such computer equipment and, as a result, the drawings are self-explanatory.

For example, error reconciliation processor 110 may be a PC based implementation of a error reconciliation processor like that of FIG. 3, or may be implemented on a platform configured as a central or host computer or server like that of FIG. 2. Such a system typically contains a central processing unit (CPU), memories, and an interconnect bus. The CPU may contain a single physical microprocessor (e.g. a suitable desktop or workstation microprocessor, such as an Intel® i7® microprocessor), or it may contain a plurality of microprocessors for configuring the CPU as a multi-processor system. The memories include a main memory, such as a dynamic random access memory (DRAM) and cache, as well as a read only memory, such as a PROM, an EPROM, a FLASH-EPROM or the like. The system memories also include one or more mass storage devices such as various disk drives, tape drives, etc.

In operation, the main memory stores at least portions of instructions for execution by the CPU and data for processing in accordance with the executed instructions, for example, as uploaded from the mass storage. The mass storage may include one or more magnetic disk drive, flash-based storage drives, tape drives, and/or optical disk drives, for storing data and instructions for use by the CPU. According to one example embodiment, at least one mass storage system in the form of a disk drive or tape drive contains the operating system and various application software. The mass storage within the computer system may also include one or more drives for various portable media, such as a floppy disk, a compact disc read only memory (CD-ROM), a DVD-ROM, a flash drive (e.g., a USB flash drive), a Blu-Ray® disc drive, an integrated circuit non-volatile memory adapter (e.g., a PC-MCIA adapter) configured to input and output data and code to and from the computer system.

The system also includes one or more input/output interfaces for communications, shown, by way of example, as an interface for data communications with one or more other processing systems. Although not shown, one or more such interfaces may be configured toneable communications via a network (e.g., to enable sending and receiving instructions electronically). The physical communication links may be optical, wired, wireless, or any suitable communication architecture.

The computer system may further include appropriate input/output ports for interconnection with a display and a keyboard serving as the respective user interface for the processor/controller. For example, a printer control computer in a document factory may include a graphics subsystem to drive the output display. The output display, for example, may include a cathode ray tube (CRT) display, a liquid crystal display (LCD), or any other suitable type of display device. The input control devices for such an implementation of the system would include the keyboard for inputting alphanumeric and other key information. The input control devices for the system may further include a cursor control device (not shown), such as a mouse, a touchpad, a trackball, stylus, and/or cursor direction keys. The links of these peripheral devices to the system may be wired connections or use wireless communications.

The computer system is configured to run a variety of applications programs and stores data, enabling one or more interactions via the user interface provided, and/or over a network to implement the desired processing, in this case, including those for tracking of mail items through a postal authority network with reference to a specific mail target, as discussed above.

The components contained in the computer system are those typically found in general purpose computer systems. Although summarized in the discussion above mainly as a PC type implementation, those skilled in the art will recognize that the class of applicable computer systems also encompasses systems used as host computers, servers, workstations, network terminals, and the like. In fact, these components are intended to represent a broad category of such computer components that are well known in the art, including, in some aspects, mobile devices, such as notebook PCs, tablet PCs, and/or smartphones. The present examples are not limited to any one network or computing infrastructure model—i.e., peer-to-peer, client server, distributed, etc.

Hence aspects of the techniques discussed herein encompass hardware and programmed equipment for controlling the relevant document processing as well as software programming, for controlling the relevant functions. A software or program product, which may be referred to as a “program article of manufacture” may take the form of code or executable instructions for causing a computer or other programmable equipment to perform the relevant data processing steps, where the code or instructions are carried by, or otherwise embodied in, a medium readable by a computer or other machine. Instructions or code for implementing such operations may be in the form of computer instruction in any form (e.g., source code, object code, interpreted code, etc.) stored in or carried by any readable medium.

Such a program article or product therefore takes the form of executable code and/or associated data that is carried on or embodied in a type of machine readable medium. “Storage” type media include any or all of the memory of the computers, processors or the like, or associated modules thereof, such as various semiconductor memories, tape drives, disk drives and the like, which may provide non-transitory storage at any time for the software programming. All or portions of the software may at times communicate through the Internet or various other telecommunication networks. Such communications networks, for example, may enable uploading of the relevant software from one computer or processor into another, for example, from a management server or host computer into the image processor and comparator. Thus, another type of media that may bear the software elements includes optical, electrical and electromagnetic waves, such as are used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium may take many forms, including, but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables, copper wire, and fiber optic cables, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards, paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

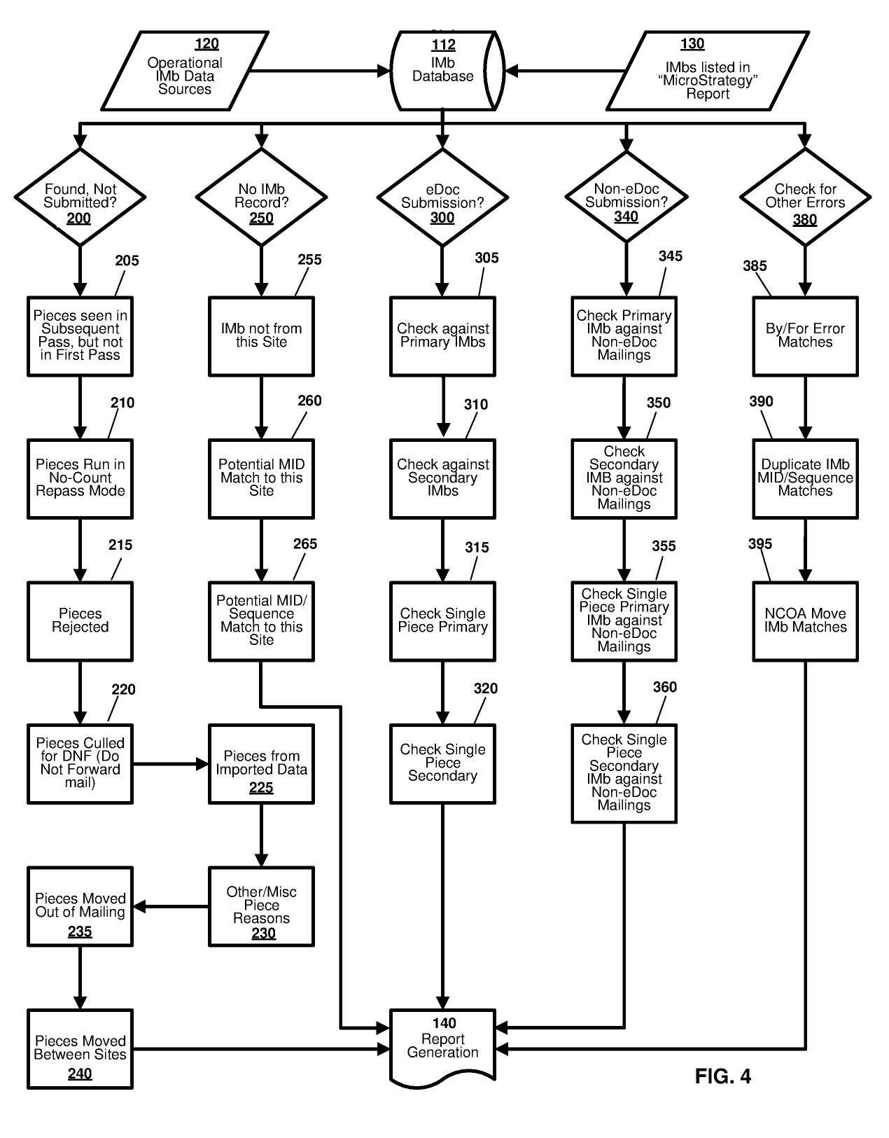

Referring now to FIG. 4, an example flow chart is shown for an error reconciliation processing method (e.g., step 116, FIG. 1) required to obtain an error reconciliation report that can be used by the mail preparer to counter the MicroSrategy report. Accordingly, data regarding the mail pieces is obtained, which is compared against the data from the “MicroStrategy” report in order to ascertain the differences therebetween and, thus, provides an opportunity for a mail preparer to better and more clearly understand what processing errors are occurring, when discrepancies are found; the resulting error report thus allows for mail preparers to make any corrections needed for future mailings and challenge any erroneous assertions of postage being due.

As illustrated in FIG. 4, both operational IMb data sources 120, which, in some aspects, is a continuous data flow from the operations/processing floor of the mail site, as well as any other data added by customers (e.g., imported print files from a list processing site, mailing reports from inserters, etc.). The operational IMb data sources 120 contain IMb data for all mail pieces across all mailings and all modes, although it is possible to restrict the operational data sources 120 to only utilize IMb data from a single mailing, or even a portion thereof. The operational IMb data sources 120 are retained by a mail preparer for a specific period of time (e.g., 6 months, but other values can be selected). The operational IMb data sources are collected from the records containing metadata for the mailings generated at each mail site of interest, as well as the IMb error report data 130 found in the “MicroStrategy” report, or other files made available by the postal authority, are received as inputs by the IMb database 112. From there, each IMb in the IMb error report data 130 is analyzed, via the error reconciliation processor 110 (see, e.g., FIG. 1), through the following 5 main steps (e.g., 200, 250, 300, 340, and 380), each of which then call for the execution of one or more subsequent processing steps. These five main steps are shown as being logically arranged and executed in parallel, however it is contemplated that other logical arrangements of these five main steps will present themselves to those having ordinary skill in the art through the discussion hereinbelow, and that such arrangements do not deviate from the scope of the present invention. The initial five primary steps will be discussed first, then each of the various processing steps associated with each of the five steps will be discussed further. In a first step, 200, each IMb listed in the “MicroStrategy” report (e.g., “the investigated IMBs”) is checked against the operational IMb data sources 120 to determine if each IMb is found but was not submitted in a MAIL.DAT file. Next, a second step, 250, is performed. In second step 250, each of the investigated IMbs is analyzed to determine if there is no record thereof in the operational IMb data sources 120. Next, a third step, 300, is performed. In the third step 300, each of the investigated IMbs is analyzed to determine whether it was included in an existing eDoc submission. Next, a fourth step, 340, is executed. In the fourth step 340, each of the investigated IMbs is analyzed to determine whether it was included in an existing non-eDoc submission. If the fourth step 340 returns a negative value (e.g., a non-eDoc submission is not discovered), then a fifth step, 380, is executed. In this fifth step 380, each of the investigated IMbs are checked for the existence of other potential errors. It is contemplated that an investigated IMb may be analyzed using one, a plurality of, or all of the five steps described herein. It is further contemplated that any of these five main steps may be bypassed if a negative result is produced at the initial inquiry, described above, of each such main step; in such an instance, the subsequent processing steps are not executed and a negative result for the pertinent main step is output to generate an error reconciliation report at 140 on FIG. 4 Additionally, other logical arrangements, where the five steps are arranged to feed the investigated IMbs into the subsequent steps, regardless of the preliminary result obtained from each step, are contemplated. Furthermore, steps may be omitted, as needed based on processing requirements, re-ordered (e.g., start with third step 300 or run each step independently of the other steps), and further steps may even be added which would be obvious to a person of ordinary skill in the art without deviating from the scope of the present invention. Each of the five primary steps 200, 250, 300, 340, and 380 will be discussed more fully hereinbelow, at least regarding the various processing steps associated with each step returning a positive result, in the following paragraphs.

According to the embodiment illustrated in FIG. 4, in the first step 200, when one of the investigated IMbs is found in the operational IMb data sources 120, but has not been submitted as part of the mailing to the postal authority, the following processing steps are executed. It will be understood that one or more of these processing steps may be omitted without deviating from the scope of the present invention. After a determination has been made that the investigated IMb if found but not submitted in first step 200, first processing step 205 is executed, where it is determined whether the mail piece having the investigated IMb was detected in a subsequent scanning and/or processing “pass” (e.g., at the inserter, the printer, the wrapper, the sorter, etc.), but was not detected in a first pass, where it should have been detected and added to the MAIL.DAT or other electronic mail submitted to the postal authority. Next, in processing step 210, it is determined whether the mail piece with the investigated IMb was run in a no-count repass mode, which is used by mail preparers to fix processing errors. For example, if mail is jumbled or otherwise becomes disorganized during processing (e.g., a tray is spilled), the mail preparer will re-sort the mail pieces, but without counting the IMbs a second time on these mail pieces for inclusion in the MAIL.DAT or other eDoc submissions. However, unsorted mail pieces can be inadvertently added to the jumbled/disorganized mail pieces through user error, which would result in a submission of mail pieces to the postal authority that is unaccounted for in the MAIL.DAT or other eDoc submissions. In the next processing step 215, it is determined whether any of the mail pieces with an investigated IMb were rejected (e.g., for a printing defect, tracking error, or any other reason why mail pieces might be rejected) during the mail processing steps at the mail site. Then, in processing step 220, it is determined whether any of the mail pieces with an investigated IMb were culled from the mailing for having a DNF (Do Not Forward) mail designation. Subsequently, in processing step 225, it is determined whether any of the mail pieces with an investigated IMb were generated from imported data; the purpose of this step is to allow for identification of the source of the investigated IMbs, so as to be able to discern imported data from what was generated natively by the processing machines; the error reconciliation report will include a designation regarding the source of the IMbs. In processing step 230, it is determined whether any other miscellaneous reasons exist for why the mail piece IMb was not submitted to the postal authority. In processing step 235, it is determined whether any of the mail pieces with an investigated IMb was designated to be moved out of the mailing during or after processing of the mailing. In processing step 240, it is determined whether any of the mail pieces with an investigated IMb were designated to be moved between mail sites (e.g., so as to be included in a MAIL.DAT file for another mailing originating from another mailing site). Finally, after each of the processing steps are executed, the results from each of these processing steps are output to generate an error reconciliation report at 140 on FIG. 4.

Continuing on to describe the processing steps executed under the second step 250, where it has been determined that no record for one or more of the investigated IMbs exists in the operational IMb data sources 120, it is determined, in a first processing step 255, whether an IMb for a mail piece having an investigated IMb did not originate from the particular mailing site where the “MicroStrategy” report indicates the IMb was received from. In processing step 260, it is determined whether an MID for the mail pieces having the investigated IMbs match an MID associated with the mailing site. In processing step 265, it is determined whether an MID and/or ID sequence for the mail pieces having the investigated IMbs matches any such MID and/or ID sequence associated with the mailing site. Finally, the results from each of these processing steps are output to generate an error reconciliation report at 140 on FIG. 4.

Referring to third step 300, where it has been determined that an eDoc submission exists, the following processing steps are executed. In a first processing step 305, the investigated IMbs returning a positive result at third step 300 are validated by checking against primary IMbs, which are the IMbs that serve as the basis for the sorting and are the IMbs reported in the eDoc submission. Most mail pieces have only a single (e.g., primary) IMB, but some pre-sorters (e.g., mail preparers) have customers with address block IMbs and the pre-sorter may need to scan a new IMb on the clear zone, which predominates over the IMb printed in the address block, according to the standard USPS operational processes. In a next processing step 310, these investigated IMbs are checked against these secondary IMbs. Next, in processing 315, it is necessary for the investigated IMbs to be checked against a primary IMb for “single piece mail.” Checking single piece mail, which is reject mail allowed to be included in mail.dat. In a penultimate processing step 320, the investigated IMbs are checked against a secondary IMb for “single piece mail.” Finally, the results from each of these processing steps are output to generate an error reconciliation report at 140 on FIG. 4.

Where fourth step 340 returns a positive result (e.g., that an investigated IMb is matched to mail submission that was not an eDoc mailing), a first processing step 345 involves checking a primary IMb of the investigated IMbs returning a positive result for fourth step 340 against non-eDoc mailings. In a next processing step 350, for these investigated IMbs, the secondary IMb will be checked against non-eDoc mailings. Next, in processing step 355, a single mail piece primary IMb will be checked against non-eDoc mailings. In the final processing step 360, a single mail piece secondary IMb is checked against non-eDoc mailings. Finally, the results from each of these processing steps are output to generate an error reconciliation report at 140 on FIG. 4.

Finally, in fifth step 380, a check for further errors will be completed. In a first processing step 385, the investigated IMbs will be checked to determine whether By/For errors are, in fact, existing. In processing step 390, it will be determined whether there are any matches for duplicated IMb MID and/or ID sequences. In processing step 395, it is determined whether there are any of the investigated IMbs that match an IMb that has a valid COA move request associated therewith. Finally, the results from each of these processing steps are output to generate an error reconciliation report at 140 on FIG. 4.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

1. A method of generating an error reconciliation report, the method comprising steps of:
receiving operational input data for each mail piece, in a form of one or more Intelligent Mailer barcode (IMb) data sources, obtained from one or more automated sensors and/or manufacturing processes, during mail processing;
receiving an error report, which comprises a list of IMbs alleged to have one or more errors associated therewith from mailings submitted to a postal authority from a mail preparer over a period of time, wherein the error report is generated automatically by the postal authority;
loading the operational input data and the error report into an IMb database;
providing an error reconciliation processor in electrical communication with the IMb database;
comparing, using the error reconciliation processor, the operational input data against the list of IMbs from the error report against one or more criteria; and
generating an error reconciliation report, which comprises results of the comparing step.

2. The method of claim 1, wherein IMbs in the list of IMbs from the error report are parsed so as to only include IMbs associated with one or more mailings.

3. The method of claim 1, wherein the automated sensors are one or more of an area capture camera, a line scan camera, and a barcode reader.

4. The method of claim 1, wherein the manufacturing processes include printers, imported data from other sites, and inserters.

5. The method of claim 1, wherein the operational input data comprises information from a partial mailing, a complete mailing, or more than one mailing.

6. The method of claim 1, wherein the error report comprises a listing of all errors associated with a mailer ID (MID) or a customer registration ID (CRID) for a specified period of time.

7. The method of claim 1, wherein comparing the operational input data against the list of IMbs from the error report comprises performing one or more subsequent steps, comprising:
determining if each IMb in the list of IMbs from the error report is found in operational input data, but was not submitted in a MAIL.DAT file to the postal authority;
analyzing each IMb in the list of IMbs from the error report to determine if there is no record of each such IMb in the operational input data;
analyzing each IMb in the list of IMbs from the error report to determine whether each such IMb was included in an existing eDoc submission provided to the postal authority;
analyzing each IMb in the list of IMbs from the error report to determine whether each such IMb was included in an existing non-eDoc submission provided to the postal authority; and
checking whether any other errors exist for each IMb in the list of IMbs from the error report.

8. The method of claim 7, wherein the step of determining if each IMb is found, but not submitted in a MAIL.DAT file, comprises one or more subsequent processing steps, including:
determining whether a mail piece having one of the IMbs in the list of IMbs from the error report was detected in a subsequent scanning and/or processing pass during mail processing, but was not detected in a first pass;
determining whether the mail piece was run in a no-count repass mode;
determining whether the mail piece was rejected during the mail processing steps at the mail site;
determining whether the mail piece was culled from the mailing for having a Do Not Forward (DNF) mail designation;
determining whether the mail piece was generated from imported data;
determining whether any other miscellaneous reasons exist for why the one of the IMbs were not submitted to the postal authority;
determining whether the mail piece was designated to be moved out of the mailing during or after processing of the mailing; and
determining whether the mail piece was designated to be moved between mail sites.

9. The method of claim 7, wherein the step of analyzing each IMb to determine if no record of such IMb exists in the operational input data comprises one or more subsequent processing steps, including:
determining whether a mail piece with an IMb in the list of IMbs from the error report did not originate from a mailing site where the error report indicates the mail piece was received from;
determining whether an MID for the mail piece with an IMb in the list of IMbs from the error report matches an MID associated with the mailing site from which the mail piece originated; and
determining whether an MID and/or ID sequence for the mail piece with an IMb in the list of IMbs from the error report matches an MID and/or ID sequence associated with the mailing site from which the mail piece originated.

10. The method of claim 7, wherein the step of analyzing each IMb to determine whether each such IMb was included in an existing eDoc submission comprises one or more subsequent processing steps, including:
checking each of the IMbs against primary IMbs for each mail piece;
checking each of the IMbs against secondary IMbs for each mail piece;
checking each of the IMbs against a primary IMb for a single piece mail designation; and
checking each of the IMbs against a secondary IMb for a single piece mail designation.

11. The method of claim 7, wherein the step of analyzing each IMb to determine whether each such IMb was included in an existing non-eDoc submission comprises one or more subsequent processing steps, including:
checking each of the IMbs against primary IMbs for mail pieces submitted in a non-eDoc mailing;
checking each of the IMbs against secondary IMbs for mail pieces submitted in a non-eDoc mailing;
checking each of the IMbs against a primary IMb for a single piece mail designation for a non-eDoc mailing; and
checking each of the IMbs against a secondary IMb for a single piece mail designation for a non-eDoc mailing.

12. The method of claim 7, wherein the step of checking whether any other errors exist for each IMb comprises one or more subsequent processing steps, comprising:
checking whether By/For errors exist for each of the IMbs in the list of IMbs from the error report;
determining whether any matches exist for duplicated IMb MID and/or ID sequences; and
determining whether there are any of the IMbs in the list of IMbs from the error report that match an IMb in the operational input data having a valid change of address (COA) move request associated therewith.

13. A system for mail piece error reconciliation, the system comprising:
an error reconciliation processor; and
an Intelligent Mailer barcode (IMb) database in electrical communication with the error reconciliation processor,
wherein the IMb database is configured to receive operational input data for each mail piece, in a form of one or more IMb data sources, from one or more automated sensors and/or manufacturing processes, during mail processing and a list of IMbs from an error report generated automatically by a postal authority,
wherein the list of IMbs from the error report comprises IMbs that are alleged to have one or more errors associated therewith from mailings submitted to a postal authority from a mail preparer over a period of time, and
wherein the error report is generated automatically by the postal authority,
wherein the error reconciliation processor is configured to access the IMb database and compare, in an automated manner, the operational input data against the list of IMbs from the error report against one or more criteria, and
wherein the error reconciliation processor is configured to, after comparing the operational input data against the list of IMbs from the error report, generate an error reconciliation report.

14. The method of claim 13, wherein the list of IMbs from the error report are parsed so as to only include IMbs associated with one or more mailings.

15. The method of claim 13, wherein the automated sensors are one or more of an area capture camera, a line scan camera, and/or a barcode reader.

16. The method of claim 13, wherein the manufacturing processes include printers, imported data from other sites, and inserters.

17. The system of claim 13, wherein the operational input data comprises information from a partial mailing, a complete mailing, or more than one mailing.

18. The system of claim 13, wherein the error report comprises a listing of all errors associated with a mailer ID (MID) or a customer registration ID (CRID) for a specified period of time.

19. The system of claim 13, wherein, when the error reconciliation processor compares, in an automated manner, the operational input data against the list of IMbs from the error report, the error reconciliation processor performs one or more subsequent steps, including:
determining if each IMb in the list of IMbs from the error report is found in operational input data, but was not submitted in a MAIL.DAT file to the postal authority;
analyzing each IMb in the list of IMbs from the error report to determine if there is no record of each such IMb in the operational input data;
analyzing each IMb in the list of IMbs from the error report to determine whether each such IMb was included in an existing eDoc submission provided to the postal authority;
analyzing each IMb in the list of IMbs from the error report to determine whether each such IMb was included in an existing non-eDoc submission provided to the postal authority; and
checking whether any other errors exist for each IMb in the list of IMbs from the error report.

20. The system of claim 19, wherein the step of determining if each IMb is found, but not submitted in a MAIL.DAT file, comprises one or more following processing steps:
determining whether a mail piece having one of the IMbs in the list of IMbs from the error report was detected in a subsequent scanning and/or processing pass during mail processing, but was not detected in a first pass;
determining whether the mail piece was run in a no-count repass mode;
determining whether the mail piece was rejected during the mail processing steps at the mail site;
determining whether the mail piece was culled from the mailing for having a Do Not Forward (DNF) mail designation;
determining whether the mail piece was generated from imported data;
determining whether any other miscellaneous reasons exist for why the one of the IMbs were not submitted to the postal authority;
determining whether the mail piece was designated to be moved out of the mailing during or after processing of the mailing; and
determining whether the mail piece was designated to be moved between mail sites.

21. The system of claim 19, wherein the step of analyzing each IMb to determine if no record of such IMb exists in the operational input data comprises one or more following processing steps:
determining whether a mail piece with an IMb in the list of IMbs from the error report did not originate from a mailing site where the error report indicates the mail piece was received from;
determining whether an MID for the mail piece with an IMb in the list of IMbs from the error report matches an MID associated with the mailing site from which the mail piece originated; and
determining whether an MID and/or ID sequence for the mail piece with an IMb in the list of IMbs from the error report matches an MID and/or ID sequence associated with the mailing site from which the mail piece originated.

22. The system of claim 19, wherein the step of analyzing each IMb to determine whether each such IMb was included in an existing eDoc submission comprises one or more following processing steps:
checking each of the IMbs against primary IMbs for each mail piece;
checking each of the IMbs against secondary IMbs for each mail piece;
checking each of the IMbs against a primary IMb for a single piece mail designation; and
checking each of the IMbs against a secondary IMb for a single piece mail designation.

23. The system of claim 19, wherein the step of analyzing each IMb to determine whether each such IMb was included in an existing non-eDoc submission comprises one or more following processing steps:
checking each of the IMbs against primary IMbs for mail pieces submitted in a non-eDoc mailing;
checking each of the IMbs against secondary IMbs for mail pieces submitted in a non-eDoc mailing;
checking each of the IMbs against a primary IMb for a single piece mail designation for a non-eDoc mailing; and
checking each of the IMbs against a secondary IMb for a single piece mail designation for a non-eDoc mailing.

24. The system of claim 19, wherein the step of checking whether any other errors exist for each IMb comprises one or more following processing steps:
checking whether By/For errors exist for each of the IMbs in the list of IMbs from the error report;
determining whether any matches exist for duplicated IMb MID and/or ID sequences; and
determining whether there are any of the IMbs in the list of IMbs from the error report that match an IMb in the operational input data having a valid COA (change of address) move request associated therewith.

25. A non-transitory computer readable medium having stored thereon non-transitory executable instructions that, when executed by the processor of a computer, control the computer to perform steps comprising:
receiving operational input data, in a form of one or more Intelligent Mailer barcode (IMb) data sources, obtained from one or more automated sensors and/or manufacturing processes, during mail processing;
receiving an error report, which comprises a list of IMbs alleged to have one or more errors associated therewith from mailings submitted to a postal authority from a mail preparer over a period of time, wherein the error report is generated automatically by the postal authority;
loading the operational input data and the error report into an IMb database;
providing an error reconciliation processor in electrical communication with the IMb database;
comparing, using the error reconciliation processor, the operational input data against the list of IMbs from the error report against one or more criteria; and
generating an error reconciliation report, which comprises results of the comparing step.

26. (canceled)
